(19) United States
(12) Patent Application Publication
(10) Pub. No.: US 2004/0037375 A1
(43) Pub. Date: Feb. 26, 2004

(54) Radio frequency tuner

(76) Inventors: Nicholas Paul Cowley, Wiltshire (GB); Mark Stephen John Mudd, Wiltshire (GB)

Correspondence Address: Mark D. Saralino, Renner, Otto, Boissell & Sklar, LLP, Nineteenth Floor, 1621 Euclid Avenue, Cleveland, OH, 44115-2191, US

(21) Appl. No.: 10/643,125

(22) Filed: Aug. 18, 2003

(30) Foreign Application Priority Data
Aug. 24, 2002 (GB) 0219765.3

(51) Int. Cl. H04L 27/06

(52) U.S. Cl. 375/344; 375/350

(57) ABSTRACT

A radio frequency tuner comprises a first frequency changer for block upconverting the channels of an input broadband signal in a first frequency range to a higher second frequency range. A multiplexer selects between the output of the first frequency changer and anyone of second broadband signals in the second frequency range. A second frequency changer has a variable frequency local oscillator for selecting and converting to I and Q baseband signals any selected channel in the broadband signal from the multiplexer.

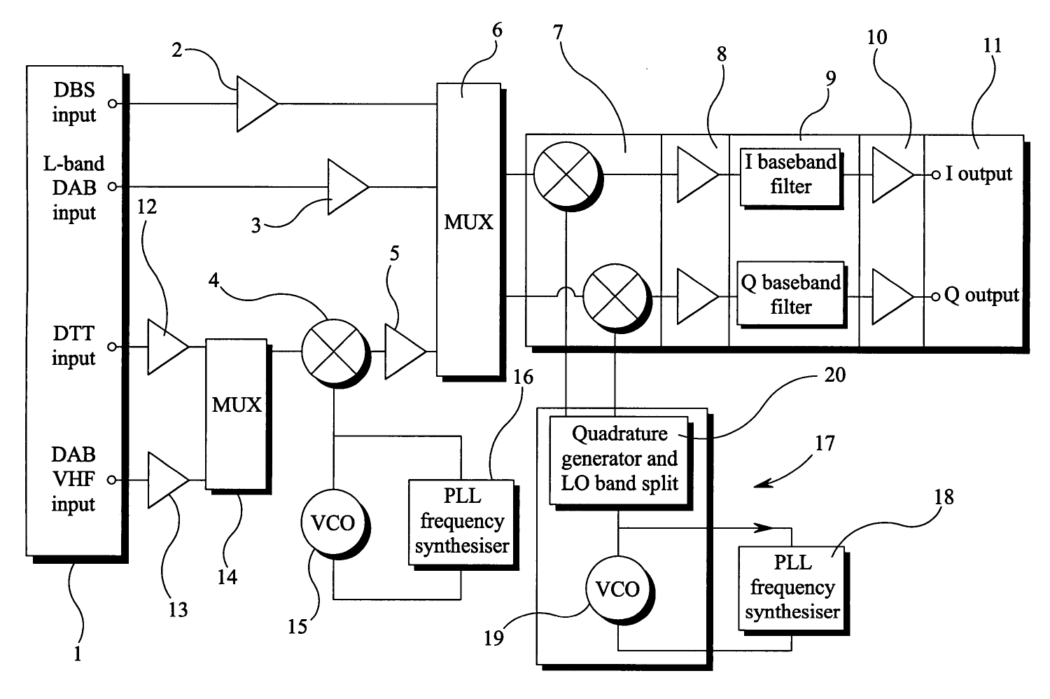

### TECHNICAL FIELD

The present invention relates to a radio frequency tuner. Such a tuner may be used, for example, as a digital tuner for interfacing between a multi-standard demodulator and a plurality of distribution media.

### BACKGROUND

With increasing levels of integration offered by deep sub-micron processes, the level of integration offered in digital demodulators has greatly expanded. It is now technically feasible and cost-effective to integrate a plurality of demodulator blocks with associated MPEG decoders and a controller processor together with various interface circuitry for accessing the modulated data within a single integrated circuit. Such a demodulator arrangement could, for example, contain one or more demodulators capable of demodulating multi level QAM (quadrature amplitude modulation), QPSK (quadrature phase shift keying), COFDM (coded orthogonal frequency division multiplex), VSB (vestigial side band), or any combination thereof. Such an interface may be used for video encoding for pictures (for example in the case of DVBT/C/S), audio encoding for example in the case of audio services (such as DAB), or any number of data interface buses where the distribution media may be pure data (for example a cable modem).

In known arrangements, the interface between radio frequency (RF) distribution media and a base band processing circuit is provided by a plurality of different tuners, each supplying a different interface signal to the demodulator. For example, satellite signals are generally converted to zero intermediate frequency (IF) or base band quadrature components before analog-digital conversion. Conversely, digital terrestrial television (DTT) COFDM is generally converted to a non-zero IF and is further processed by IF amplifiers with interstage surface acoustic wave (SAW) filters, after which the composite signal is converted to the digital domain for demodulation. Such arrangements are cumbersome and do not provide a simple interface between the RF and digital domains. Instead, a plurality of tuners of different architecture are used with different interface means to, for example, a baseband chip containing all of the demodulation functions.

JP 11341373 discloses a tuner comprising a downconverter which converts a signal in the range 950 to 2150 MHz directly to quadrature near zero intermediate frequency signals. An upconverter converts terrestrial signals in the frequency range 50 to 860 MHz to a higher fixed frequency within the band of the satellite signals. The I and Q outputs are low-pass filtered before being output for demodulation.

A local oscillator switching arrangement is provided so that the local oscillator which is responsible for tuning to the required channel is used for the downconverter when receiving satellite signals and for the upconverter when receiving terrestrial signals. In the latter case, a second fixed frequency local oscillator is used with the downconverter. Thus, the terrestrial signals are converted to an intermediate frequency of 950 MHz and then downconverted to baseband.

### SUMMARY

According to the invention, there is provided a radio frequency tuner comprising: a first frequency changer having a substantially fixed frequency local oscillator for performing a block substantially fixed frequency up conversion of the channels in any one of at least one first broadband signal in a first frequency range to a second higher frequency range; a first multiplexer for selecting any one of an output signal of the first frequency changer and at least one second broadband signal in the second frequency range: and a second frequency changer having a variable frequency local oscillator for selecting and converting to baseband any channel of the broadband signal selected by the multiplexer.

The frequency range of the frequency-converted at least one first broadband signal may overlap with the frequency range of the at least one second broadband signal.

The tuner may comprise a second multiplexer for selecting any one of a plurality of first broadband signals for conversion by the first frequency changer.

The second frequency changer may be a quadrature frequency changer.

The tuner may comprise a variable bandwidth filter for filtering the or each output signal of the second frequency changer. The or each filter may be a low pass filter.

The variable frequency local oscillator may have a tuning range at least as wide as the second frequency range.

The substantially fixed frequency local oscillator may have a relatively narrow tuning range. As an alternative, the substantially fixed frequency local oscillator may have a fixed frequency.

The tuner may comprise a single monolithic integrated circuit.

It is thus possible to provide a single tuner architecture which can cater for many or all of the RF to digital interfacing, for example ahead of a demodulation arrangement capable of demodulating many or all types of modulation standards. For example, such an arrangement may be arranged to provide interfacing for any combination of digital audio broadcasting (DAB), digital terrestrial television (DTT), digital broadcast satellite (DBS), and cable distribution. No complex oscillator switching arrangement is needed and no channel filtering is necessary ahead of the second frequency changer. Such a tuner may provide a relatively simple interface to a demodulator function from a plurality of dissimilar frequency sources transmitted over dissimilar frequency ranges.

### BRIEF DESCRIPTION OF THE DRAWINGS

The accompanying drawing is a block circuit diagram of a radio frequency tuner constituting an embodiment of the invention.

### DETAILED DESCRIPTION

The tuner has a multiple input 1 which, in the example illustrated, is provided for DBS, L-band DAB, DTT and DAB in the VHF band. The DBS and L-band DAB inputs are connected via respective amplifier stages 2 and 3, which may provide an automatic gain control function, to a multiplexer (MUX) 6. The DTT and DAB VHF inputs are supplied via amplifier stages 12 and 13, which may also provide an automatic gain control function, to another multiplexer 14.

The output of the multiplexer 14 is supplied to a frequency changer comprising a mixer 4 and a local oscillator 15 in the form of a voltage controlled oscillator (VCO) is controlled by a phase locked loop (PLL) frequency synthesiser 16. The output of the mixer 4 is supplied via another amplifier stage 5 to a further input of the multiplexer 6.

The output of the multiplexer 6 is supplied to a quadrature zero intermediate frequency or base band frequency changer comprising mixers 7 and a quadrature local oscillator 17 controlled by a PLL frequency synthesiser 18. The local oscillator comprises a VCO 19 and a quadrature generator and band split arrangement 20. The PLL frequency synthesisers 16 and 18 may share common stages such as a bus interface and a reference divider.

The I and Q baseband signals from the mixers 7 are supplied via baseband amplifiers 8 to I and Q baseband filters 9. These filters, which may be embodied as low pass filters, have a variable frequency bandwidth which can be adjusted to cover all possible standards to be received. The outputs of the filters 9 are supplied to amplifier stages 10, which supply the I and Q output signals to the tuner outputs 11.

Any one input at a time may be selected by suitably controlling the multiplexers 6 and 14. The first frequency changer 4, 15, 16 performs an up-conversion, which may be a fixed frequency conversion or which may be tunable over a narrow range, for example so as to avoid undesirable effects of beating between the oscillator harmonics. The first frequency changer thus performs a block up-conversion of the broadband signal selected by the multiplexer 14. This conversion is to a frequency range which substantially overlaps the frequency ranges of broadband signals supplied directly to the multiplexer 6.

The frequency strategy is such as to avoid harmonic mixing effects. In a typical application, the broadcast terrestrial band (from the multiplex 14) covers a frequency range from 50 to 860 MHz. If a quadrature downconverter were applied directly, then for frequencies up to 860/3 MHz the third harmonic frequency of the oscillator would lie within the received band. As a consequence, unless band split filtering were applied in front of the mixer, the channel corresponding to the third harmonic would also be downconverted to baseband and so appear as a distortion signal on the desired channel. A similar distortion effect would occur for other odd harmonics of the local oscillator.

The tuner shown in the drawing overcomes this effect without the requirement for band split filters since the first upconversion frequency changer (4, 15, 16) utilises an oscillator frequency above the broadcast band and hence there are no channels within the desired band which will correspond to harmonics of the local oscillator. The quadrature downconversion to zero IF output typically downconverts any channel in the frequency range 1-2 GHz. Again, the third harmonic of the local oscillator will lie outside of either the received or block upconverted frequency band.

An example frequency strategy may be as follows

| | | |
|---|---|---|
| Terrestrial | mixer | Upconverted terrestrial |
| (50-860 MHz) | (LO @ 1.1 GHz) | (1.15-1.96 GHz) |
| Satellite | Ina | Common overlapping band |
| (950-2150 MHz) | | (0.95-2.15 GHz) |

In this example, the frequency of the VCO 15 is set to 1.1 GHz so that the terrestrial band is block upconverted from 50-860 MHz to 1.15-1.96 MHz. The satellite band is 950-2150 MHz and contains the upconverted terrestrial band. The VCO 17 is tuneable over the range 950-2150 MHz (0.95-2.15 GHz) so as to convert any received channel to baseband.

Channel selection is performed exclusively or substantially exclusively by the second frequency changer. The second frequency changer is therefore tunable over a range of frequencies which covers all of the channel frequencies which may be output by the multiplexer 6. In order to avoid interfering artefacts, the frequencies of both the frequency changers may be offset slightly.

It is thus possible to provide a single architecture for a tuner such that it is capable of receiving and converting to baseband anyone of a plurality of different input signals in different frequency ranges and with different modulation standards. Automatic gain control strategies and baseband filtering parameters may be selected in accordance with the modulation standard of the broadband input signal currently selected by the multiplexers 6 and 14. A very high degree of integration may be achieved and it is possible to integrate the whole tuner as a single monolithically integrated circuit. A single RF interface may therefore be provided ahead of a multi-standard single chip demodulation arrangement.

What is claimed is:

1. A radio frequency tuner comprising: a first frequency changer having a substantially fixed frequency local oscillator for performing a block substantially fixed frequency upconversion of channels in any one of at least one first broadband signal in a first frequency range to a second higher frequency range;
a first multiplexer for selecting any one of an output signal of said first frequency changer and at least one second broadband signal in said second frequency range; and
a second frequency changer having a variable frequency local oscillator for selecting and converting any channel of a broadband signal selected by said multiplexer.

2. A tuner as claimed in claim 1, in which a frequency range of said at least one first broadband signal after said upconversion by said first frequency changer overlaps with a frequency range of said at least one second broadband signal.

3. A tuner as claimed in claim 1, comprising a second multiplexer for selecting any one of a plurality of first broadband signals for conversion by said first frequency changer.

4. A tuner as claimed in claim 1, in which said second frequency changer is a quadrature frequency changer.

5. A tuner as claimed in claim 1, comprising a variable bandwidth filter for filtering an output signal of said second frequency changer.

6. A tuner as claimed in claim 5, in which said filter is a low pass filter.

7. A tuner as claimed in claim 1, in which said variable frequency local oscillator has a tuning range at least as wide as said second frequency range.

8. A tuner as claimed in claim 1, in which said substantially fixed frequency local oscillator has a relatively narrow tuning range.

9. A tuner as claimed in claims 1, in which said substantially fixed frequency local oscillator has a fixed frequency.

10. A tuner as claimed in claim 1, comprising a single monolithic integrated circuit.
